(19) United States
(12) Patent Application Publication
(10) Pub. No.: US 2024/0152176 A1
(43) Pub. Date: May 9, 2024

(54) DYNAMIC OPTIMIZATION AND HEALTH MONITORING FOR BLOCKCHAIN PROCESSING DEVICES

(71) Applicant: Luxor Technology Corporation, Bellevue, WA (US)

(72) Inventor: Jan Beck, Roseville, CA (US)

(21) Appl. No.: 18/502,892

(22) Filed: Nov. 6, 2023

Related U.S. Application Data
(60) Provisional application No. 63/490,695, filed on Mar. 16, 2023.
(60) Provisional application No. 63/423,396, filed on Nov. 7, 2022.

(51) Int. Cl. G06F 1/10; G06F 1/3296

(52) U.S. Cl. CPC G06F 1/10; G06F 1/3296

(57) ABSTRACT

In an implementation, a first set of operational data is collected from each processing unit of one or more processing units during a first time period. Based on the first set of operational data, one or more operational parameters of the one or more processing units are modified. The one or more processing units are dynamically configured based on the one or more operational parameters. A second set of operational data is collected from each processing unit of the one or more processing units during a second time period. Using at least one metric, at least one change in performance of the one or more processing units is determined based on a comparison of the first and second set of operational data. A modified configuration is determined based on the change in performance and used to configure the one or more processing units for operation.

### CROSS-REFERENCE TO RELATED APPLICATION

This application claims the benefit of U.S. Provisional Application No. 63/423,396, filed Nov. 7, 2022, and U.S. Provisional Application No. 63/490,695, filed Mar. 16, 2023, the contents of which are incorporated by reference herein.

### BACKGROUND

The present disclosure relates to the dynamic optimization and health monitoring of computational devices that are deployed for blockchain processing, with one such application being the mining of cryptocurrency.

Optimal performance of devices deployed for blockchain processing may be different from one user to the next based on each user's objectives. As such, there are multiple permutations of performance metrics that can be defined as “optimal performance” of a device.

Optimization of devices for blockchain processing can take place at various levels, such as optimization of individual components of a device (for example, semiconductor chips or boards), or more holistically across a collection of devices.

For computing devices used to mine cryptocurrency (“miners” or “machines”), optimization can be enabled by adjusting operating settings on the machine, such as the frequency and voltage at which its chips operate. These operating settings are controlled by a miner's firmware.

The firmware installed on the miner when initially purchased from a machine manufacturer can be replaced by a custom developed firmware. Custom firmware provides more flexibility with respect to what operating settings can be adjusted on a miner and, as result, provides additional ways to optimize the performance of the machine.

### SUMMARY

The present disclosure describes dynamic optimization and health monitoring of a collection of computational devices that are deployed for blockchain processing, with one such application being the mining of cryptocurrency.

In an implementation, a computer-implemented method for configuring one or more processing units, the method comprises: collecting a first set of operational data from each processing unit of the one or more processing units during a first time period; modifying, based on the first set of operational data, one or more operational parameters of the one or more processing units; dynamically configuring the one or more processing units based on the one or more operational parameters; collecting a second set of operational data from each processing unit of the one or more processing units during a second time period; determining, using at least one metric, at least one change in performance of the one or more processing units based on a comparison of the first set of operational data and the second set of operational data; determining a modified configuration based on the change in performance; and configuring the one or more processing units for operation based on the modified configuration.

The described subject matter can also be implemented using a non-transitory, computer-readable medium storing computer-readable instructions to perform the computer-implemented method and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the performance of one machine or a collection of machines can be optimized by deploying operating settings using remote means. Secondly, historical performance data from machines can be statistically processed to identify operating settings that result in desired performance objectives. This will provide operators with a guide for what operating settings to deploy to optimize the performance of an individual machine or a collection of machines. Third, historical performance data can be statistically processed to gain further insight into the operating health of machines when different operating settings are applied. This insight can be used to determine when machines may fail or require maintenance based on the operating settings deployed. Further advantages could include, for example, optimizing performance in terms of individually optimizing a ratio between power consumption and output (for example, terahashes per second (TH/sec)) per computing unit (for example, a central processing unit (CPU), graphics processing unit (GPU), or application-specific integrated circuit (ASIC)). Further advantages could include, for example, optimizing performance in terms of individually optimizing a ratio between output and life expectancy/mean time to failure (MTTF) per computing unit.

According to this specification, in a 1^{st} aspect, a computer-implemented method for processing unit configuration, comprising: collecting a first set of operational data from each processing unit of one or more processing units during a first time period; modifying, based on the first set of operational data, one or more operational parameters of the one or more processing units; dynamically configuring the one or more processing units based on the one or more operational parameters; collecting a second set of operational data from each processing unit of the one or more processing units during a second time period; determining, using at least one metric, at least one change in performance of the one or more processing units based on a comparison of the first set of operational data and the second set of operational data; determining a modified configuration based on the change in performance; and configuring the one or more processing units for operation based on the modified configuration.

In a 2^{nd} aspect according to aspect 1, comprising: sequentially pushing the one or more processing units to an extreme operating point; and determining state information of the one or more processing units when the one or more processing units are at the extreme operating point.

In a 3^{rd} aspect according to any of aspects 1 to 2, wherein the state information includes one or more of maximum clock frequency, temperature, power used, minimum necessary voltage and efficiency.

In a 4^{th} aspect according to any of aspects 1 to 3, wherein the extreme operating point includes one or more of frequency setpoint, voltage setpoint, ventilation, and ambient conditions.

In a 5^{th} aspect according to any of aspects 1 to 4, wherein measurements of temperature are used to control a frequency of operation of the one or more processing units.

In a 6^{th} aspect according to any of aspects 1 to 5, wherein statistical methods are used to identify correlations between variables by analyzing a large number of measurements from a given processing unit.

In a 7^{th} aspect according to any of aspects 1 to 6, wherein statistical methods are used to identify correlations between variables by analyzing a large number of measurements from multiple processing units.

In an 8^{th} aspect according to any of aspects 1 to 7, wherein at least one of (i) the first set of operational data or (ii) the second set of operational data comprises current costs for a unit of energy; or at least one of (i) the first set of operational data or (ii) the second set of operational data comprises a type of an energy source that powers the one or more processing units.

According to this specification, in a 9^{th} aspect, a non-transitory, computer-readable medium storing one or more instructions executable by a computer system to perform one or more operations for processing unit configuration, comprising: collecting a first set of operational data from each processing unit of one or more processing units during a first time period; modifying, based on the first set of operational data, one or more operational parameters of the one or more processing units; dynamically configuring the one or more processing units based on the one or more operational parameters; collecting a second set of operational data from each processing unit of the one or more processing units during a second time period; determining, using at least one metric, at least one change in performance of the one or more processing units based on a comparison of the first set of operational data and the second set of operational data; determining a modified configuration based on the change in performance; and configuring the one or more processing units for operation based on the modified configuration.

According to this specification, in a 10^{th} aspect, a computer-implemented system for processing unit configuration, comprising: one or more computers; and one or more computer memory devices interoperably coupled with the one or more computers and having tangible, non-transitory, machine-readable media storing one or more instructions that, when executed by the one or more computers, perform one or more operations, comprising: collecting a first set of operational data from each processing unit of one or more processing units during a first time period; modifying, based on the first set of operational data, one or more operational parameters of the one or more processing units; dynamically configuring the one or more processing units based on the one or more operational parameters; collecting a second set of operational data from each processing unit of the one or more processing units during a second time period; determining, using at least one metric, at least one change in performance of the one or more processing units based on a comparison of the first set of operational data and the second set of operational data; determining a modified configuration based on the change in performance; and configuring the one or more processing units for operation based on the modified configuration.

According to this specification, in an 11^{th} aspect, a computer-implemented method for processing unit configuration, comprising: collecting a first set of operational data of a first set of one or more components of a plurality of components based on one or more measurements performed using one or more sensors associated with the first set of one or more components; and estimating a second set of operational data of a second set of one or more components different from the first set of one or more components based on the first set of operational data.

In a 12^{th} aspect according to aspect 11, comprising: determining a correlation of operational data between at least one component of the first set of one or more components and at least one component of the second set of one or more components.

In a 13^{th} aspect according to any of aspects 11 to 12, comprising: determining, as a determined correlation, a configuration for operating the second set of one or more components based on the determined correlation.

In an 14^{th} aspect according to any of aspects 11 to 13, comprising: determining, from at least one of (i) the first set of operation data or (ii) the second set of operational data, an incipient failure of any one or more of the first set of one or more components or the second set of one or more components, respectively.

In a 15^{th} aspect according to any of aspects 11 to 14, comprising: the computer-implemented method is performed by a remote entity.

In a 16^{th} aspect according to any of aspects 11 to 15, comprising: determining, from at least one (i) the first set of operation data or (ii) the second set of operational data an optimized configuration for operating at least one component of the one or more components, wherein the optimized configuration causes the at least one component of the one or more components to enter into or maintain an operational state that is optimized for one of: power usage, mean time to failure, an expected error rate, hash rate, a ratio of hash rate and power usage, or a ratio of hash rate and waste heat.

In a 17^{th} aspect according to any of aspects 11 to 16, wherein at least one of (i) the first set of operational data or (ii) the second set of operational data comprises current costs for a unit of energy.

In a 18^{th} aspect according to any of aspects 11 to 17, wherein at least one of (i) the first set of operational data or (ii) the second set of operational data comprises a type of an energy source that powers the first set of one or more components or the second set of one or more components, respectively.

According to this specification, in a 19^{th} aspect, a non-transitory, computer-readable medium storing one or more instructions executable by a computer system to perform one or more operations, comprising: collecting a first set of operational data of a first set of one or more components of a plurality of components based on one or more measurements performed using one or more sensors associated with the first set of one or more components; and estimating a second set of operational data of a second set of one or more components different from the first set of one or more components based on the first set of operational data.

According to this specification, in a 20^{th} aspect, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: collecting a first set of operational data of a first set of one or more components of a plurality of components based on one or more measurements performed using one or more sensors associated with the first set of one or more components; and estimating a second set of operational data of a second set of one or more components different from the first set of one or more components based on the first set of operational data.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a graph depicting a plot of generated heat and hash rate vs frequency, according to an implementation of the present disclosure.

FIG. 2 is a graph depicting failure rate for a complicated system as a function of time, according to an implementation of the present disclosure.

FIG. 3 is a block diagram depicting airflow in a representative machine, according to an implementation of the present disclosure.

FIG. 4 is a graph depicting possible temperature profiles over time for two chips in a machine, according to an implementation of the present disclosure.

FIG. 5 is a plot depicting chip temperature vs chip voltage, according to an implementation of the present disclosure.

FIG. 6 is a scatter plot depicting exhaust temperature vs voltage of i^{th} chip, according to an implementation of the present disclosure.

FIG. 7 is a block diagram depicting a single complete processing unit or “chip” used in a machine, according to an implementation of the present disclosure.

FIG. 8 is a block diagram depicting a collection of chips in a collection of machines such as at one farm, according to an implementation of the present disclosure.

FIG. 9 is a flowchart illustrating an example of a computer-implemented method for dynamically optimizing the performance of a machine, according to an implementation of the present disclosure.

FIG. 10 is a graph depicting a probability density for the maximum clock frequency for a large collection of identical chips at a fixed temperature, according to an implementation of the present disclosure.

FIG. 11 is a graph depicting the probability density for the maximum clock frequency for a collection of identical chips under two different temperature scenarios, according to an implementation of the present disclosure.

FIG. 12 is a graph depicting probability densities for the maximum clock frequency of a collection of chips under different temperature operating conditions, according to an implementation of the present disclosure.

FIG. 13 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes dynamic optimization and health monitoring of computational devices that are deployed for blockchain processing, with one such application being the mining of cryptocurrency. The description is presented in a way meant to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

A cryptocurrency is a digital medium of exchange in which cryptography governs the creation and exchange of value. There have been many proposed cryptocurrencies, of which the best-known is probably Bitcoin. Without loss of generality, this disclosure will be directed specifically at Bitcoin, although it will be obvious to an individual of ordinary skill in the art that the concepts can also be applied to other cryptocurrencies or to more general blockchain constructs.

With respect to the Bitcoin protocol, the validation of new blocks added to the blockchain and the creation of new units of bitcoin occurs through a process known as proof-of-work (“POW”). POW participants utilize computers to solve cryptographic computational puzzles. These puzzles are solved through a guess-and-check like system in which computers test potential solutions until the computational puzzle is solved (that is, they are solved by brute force). Once solved, a new block is added to the blockchain and the participant responsible for submitting the correct solution to the computational puzzle receives a reward that includes any new bitcoin minted from the protocol and fees from transactions included in the block.

While one or more general purpose computers could be used for generating potential solutions to the POW computational puzzles, most participants use specialized hardware devices that, in some cases, can test over a hundred trillion solutions per second. The rate at which computers can generate new solutions is known as its “hashrate”. The probability that any given computer will successfully solve the computational puzzle is proportional to its hashrate divided by the total hashrate of all computers competing to find a solution. At the time of this disclosure, it is estimated that the total hashrate of all computers participating in the Bitcoin POW process is over 460 quintillion tests per second.

The specialized hardware devices used to solve POW computational puzzles are commonly referred to as “machines” or “miners.” A machine may be comprised of various components, including chips, boards, a housing, ventilation fans, and a power supply. Given an analogy to a gold prospector, a miner must sift through a great deal of dirt (incorrect solutions) before finding a nugget of gold (a correct solution).

For the purposes of this disclosure, a “chip” refers to a single complete processing unit or node that is dedicated to solving a cryptographic computational puzzle. This chip might consist of one or more integrated circuits interconnected with the electronic components needed to comprise a complete functional unit. One or more chips may be placed on a printed circuit board or “board”. With multiple chips, a board can execute multiple trial solutions to a cryptographic puzzle in parallel. A collection of one or more boards is often placed into a single housing. The housing can include intake and exhaust fans for ventilation. Ventilation fans draw in external air and pass it by the boards to cool the components on the boards. As such, the cooling of every board within a miner might be impacted by the airflow enabled by the machine's ventilation fans. A power supply is typically attached to the housing and may also include its own ventilation fans. In a typical machine design, the power supply provides power to each board at a certain voltage level. As such, every chip on a given board might receive power at the same voltage level.

Operators of machines will typically locate a collection of machines in a geographically unique facility, often called a “farm.” All the miners in a farm draw on the same external power, so that power pricing and local grid dynamics would impact all miners in a farm in a similar way.

For a single, individual machine, there are typically at least three significant component-related variables that an operator can control to influence the individual machine's performance (that is, its hashrate level) and longevity:
1. Frequency of the individual chips,
2. Voltage applied to individual chips or groups of chips, and
3. Internal cooling and/or ventilation.

Generally, higher-frequency operations result in an increased hashrate, and having higher voltages allows for higher-frequency switching. As such, there are two controls that can allow a given chip to operate with a higher hashrate, namely, increasing board voltage and increasing chip frequency. However, higher voltages can lead to long-term failures due to electromigration within the chip's transistors. In addition, operating a chip at both high-voltage and high-frequency may generate excessive heat energy as a by-product. The heat energy can be removed through a well-designed cooling and/or ventilation system inside the miner. By increasing the fan speed for a ventilation system, air flow over critical components can be used to effectively remove and exhaust heat energy outside the miner.

However, fans require power, and there may be other issues limiting fan use (such as, excessive noise or vibration). Moreover, effectiveness of air cooling is a function of the temperature of the air at an air intake. In a farm having many machines, the specific location of a given machine within the farm may impact the temperature and flow of air that is available for cooling use. It should be noted that some cooling techniques utilize a fluid, such as freon or water, rather than air and may need pumps rather than fans, but the challenge of removing excess heat from critical components remains the same.

Perhaps the biggest challenges affecting the longevity of electronic components are high operating temperatures and thermal cycling. Models for impact of temperature on the estimated life of an electronic component rely heavily on a known Arrhenius equation, which relates rates of chemical reactions to temperature. For example, a reliance on this model has given birth to a rule-of-thumb that “every 10° C. increase in temperature reduces electronic component life by half”. This rule-of-thumb is often used by component manufacturers to carry out accelerated life testing at elevated temperatures in order to obtain estimates of mean time to failure in reasonable time frames. While the Arrhenius model may be appropriate for failure mechanisms (such as, corrosion, electromigration, and dielectric breakdown), it is known in the industry that the Arrhenius equation is not suitable for other significant failure modes (such as, the formation of conductive filaments, contact interface stress relaxation, and fatigue of interconnects), which arise more frequently from thermal cycling. Since elevated temperatures can lead to premature failure of electronic systems (such as, the chips for a machine), an important strategy for maximizing useful life of a machine is to monitor and then manage its operating temperature and to avoid hot spots.

Operators of machines are profit driven and, thus, seek to operate their machines at an optimal performance level. However, an optimal performance level for the machines may be different from one user to the next based on the user's specific objectives. An operator's objectives may be influenced by a variety of external factors, such as the market price of cryptocurrency, the market price of machines, the cost of power, and the source of power (for example, whether the power is “green” or not).

As a first example, an operator may have an objective of maximizing the useful life of their machines, so that they can delay paying for new machines for as long as possible. This operator may choose to turn machines off on hot days when machines could be damaged from elevated temperatures and/or schedule more frequent downtimes to perform maintenance. As a second example, a different operator may choose to operate their machines more aggressively as the date of a Bitcoin halving event approaches (a Bitcoin halving occurs roughly every four years and marks the time at which the amount of newly minted bitcoin received for solving the crypto puzzle is reduced by half, thus reducing the profitability for operators). By operating machines more aggressively leading up to a halving, the operator risks a higher failure rate for their machines under the rationale that profits will soon decrease. As a third example, many operators enter into power purchase agreements which allow them to purchase electrical power at a fixed price. This operator's objective may be to take advantage of differences in the fixed rate of power they receive and the spot price of power. They may be able to do so by selling their power back to the grid when the profitability of doing so is higher than keeping their machines running. In this case, the operator may turn on/off their machines more proactively than other operators in response to power pricing and their profitability levels.

Optimization of devices for blockchain processing can take place at various levels, such as optimization of individual components of a device (for example, semiconductor chips or boards), or more holistically across a collection of devices (such as, a farm).

For computing devices used to mine cryptocurrency (“miners” or “machines”), optimization can be enabled by adjusting operating settings on the machine, such as the frequency and voltage at which its chips operate. These operating settings are controlled by a miner's firmware.

The firmware installed on the miner when initially purchased from a machine manufacturer can be replaced by a custom developed firmware. Custom firmware provides more flexibility with respect to what operating settings can be adjusted on a miner and, as result, provides additional ways to optimize the performance of the machine. For example, custom firmware may have a built-in auto-tuning feature, whereby the firmware will adjust the frequency and voltage at which the chips operate in order to improve a hashrate and/or manage temperatures. In some implementations, custom firmware for each miner can be configured with its own GUI interface and API functionality. As previously noted, optimization can also occur across a collection of devices. For example, when multiple mining machines are operating on the same network, operating settings for individual miners can be adjusted to optimize for a collective performance objective. In some implementations, this optimization for a collection of devices can be performed using a dedicated software platform that could also serve as a centralized monitoring tool.

Currently, custom firmware can adjust machine operating settings under local control, with the machine needing to reboot when operating settings change. This leads to downtime and an inability for machine operators to adjust operating settings in real-time to accomplish desired optimization objectives. Furthermore, auto-tuning features for existing custom firmware require the machine to cycle through various combinations of voltage and frequency before finding correct levels to apply to chips for a desired performance effect. This process may take up to several hours and result in additional periods of downtime.

The present disclosure describes a computer system in which custom firmware settings can be deployed and adjusted remotely, allowing for reduced downtime and an ability to dynamically optimize performance of one machine or a collection of machines. In terms of optimization, operators can remotely manage the hashrate of each individual processing unit of a miner, that is, each chip, by adjusting applied voltage and operating frequency, while balancing competitive needs of power management and component lifetimes.

These settings changes could be executed using individual machines' GUI interfaces and API functionality or using a software platform that enables batch modifications on multiple machines at once. For example, a user may be able to setup the same mining pool, same worker profiles, and enable chip tuning for an entire collection of machines at once. These settings changes could allow users to make settings changes at a single point in time or dynamically in response to various operating conditions. With the software platform, users could optimize each individual machine or optimize all machines for a collective goal. For example, a user could make bulk configuration changes through the software platform to direct electricity to the best performing machines and/or chips. This ability may be relevant if the availability of electricity becomes an operational constraint, for instance, due to infrastructure failure or downtime or due to market factors, such as elevated electricity pricing at a given time. This software platform could also be used for centralized monitoring of machines. For example, using the software platform, a user may be able to monitor health of machine components, network connection status, and past operating performance.

Aggregated performance data from the computer system such as the software platform described above can be analyzed to help operators determine what operating settings to implement given desired performance objectives, as well as to determine when machines may fail or require maintenance based on the deployed firmware settings. By capturing data from a wide variety of conditions and archiving a historical database, it is possible to apply statistical tools to improve overall machine performance and specific machine health/operational longevity. In particular, incipient failures can be anticipated, and proactive maintenance schedules can be identified.

In general, different types of machines have different chip designs. Additionally, every chip has a unique operating envelope of adjustable voltages and frequencies, which are imposed by manufacturing tolerances. For a given chip, the system described in the present disclosure can develop an archival fingerprint describing the chip's performance under various operating conditions. Over time, an archive of fingerprints of many chips from machines that use the system can be analyzed to identify optimal operational modes, undesirable operational conditions, and chip health. In some implementations, a chip fingerprint can have a form:

Fᵢ(t)[f,v,Tᵢₙₜₐₖₑ,Tₑₓₕₐᵤₛₜ,T_{board},T_{chip},Eₜᵢₘₑ,B,hr,H,P,m,L,M_{date}], (1)

where:
Fᵢ(t)=Record for the i^{th} chip in a collection of chips at time t
f=chip frequency
v=chip voltage
Tᵢₙₜₐₖₑ=temperature of air intake to the miner housing the chip
Tₑₓₕₐᵤₛₜ=temperature of exhaust temperature
T_{board}=temperature of the board on which the chip is mounted
T_{chip}=temperature of the chip
Eₜᵢₘₑ=total time in service
B=brand of chip
hr=hash rate that was accomplished
H=intake air humidity
P=particulates in the air
m=specific miner that houses the chip
L=specific location of chip within the miner
M_{date}=date of manufacture of chip.

Information in equation (1) is non-exhaustive. Fingerprints that include fields not shown in the form above or one or more reduced versions of the fingerprint shown above could be used in an implementation of the present disclosure.

Some of the constituents of a fingerprint can be variable in time. Others can be fixed in time, such as a specific machine that houses an ith chip, a specific location of the ith chip within the machine, a brand of the ith chip, or a date of manufacture of the ith chip or machine.

Some of the variables will be common to multiple chips. For example, Tᵢₙₜₐₖₑ and Tₑₓₕₐᵤₛₜ are functions of a machine and impact all chips within the machine. However, since the ith chip could be located at different positions within the machine, the impact of ventilation on performance may be different for a neighboring chip.

In some implementations, a database of fingerprints of all chips over an ever-increasing time interval can be analyzed to provide actionable data. As a first example, if a chip temperature, T_{chip}, increases over board temperature, T_{board}, by a significant amount relative to historical deltas, this could be indicative of an incipient failure. It might be addressed by either turning off the chip or by downclocking the chip (for example, reducing the chip's voltage received or frequency), and flagging the miner for future repair. Using statistical analysis, the system can also analyze a set of circumstances that led to the failure condition.

As a second example, a measure of particulates (such as, dust) might be carried out by one or more particulate counters located within a farm of many machines. This might serve as a proxy for cleanliness. When there is a significant temperature rise on multiple chips within a machine, an operator can go back in time to analyze the history of air particulates and gauge whether dust build-up, for example, on heat sinks, needs to be addressed. In this way, a historical archive of particulates and temperature can be used to direct service schedules and possible remediation efforts.

As a third example of how an archived database of chip fingerprints might be used, perhaps there are some chips that experience a lower temperature rise above the intake temperature, indicating that they might be amenable to an increase in frequency and an expected associated increase in hashrate. These chips might have reduced temperatures because their specific manufacturing tolerances combine in a particularly favorable way, in which case chip management would be very much targeted at an individual level. Or it may be that a particular chip's position within a specific machine design receives superior ventilation, so that chips in that position in all units having a similar design can operate at an increased frequency. This information can also be useful in situations where optimization is done for maximum efficiency, since chips run more efficiently at a particular hashrate when kept cooler.

As seen, historical fingerprint data can be used to determine chip failure modes, to anticipate failures, and to develop best practices for machine management. By archiving a characteristic fingerprint of performance for each individual chip, statistical tools can be applied after-the-fact to identify what operational parameters are of primary importance and which are of secondary importance/unimportant.

Perhaps the most important statistical tool is the use of correlation. Correlation is a measure of the relationship between two variables. As an example, in a chip, the hashrate is directly proportional to the chip frequency. As a result, it is expected that hashrate and chip frequency are highly correlated. As another example, it is anticipated that for a given chip frequency, chip temperature will be correlated to air intake temperature and will be correlated to a position of the chip within a miner. Information embodied in a chip fingerprint allows an analysis of variations over time and a determination of a degree of correlation.

As an example of the way in which a user of the system described in the present disclosure can use statistical tools on remote data to optimize miner performance, consider a use of maximum frequency as a proxy for chip temperatures. An individual machine often has hundreds of chips mounted on multiple boards. Even when temperature can only be measured from a few representative chips, it may be possible to obtain a statistical temperature model for chips that do not have an integrated temperature sensor and to use this information to optimize an overall hashrate of the machine.

In some cases, the process is iterative. First, for a specific machine, all chips are set to operate at a nominal frequency for a sufficiently long period of time that all chips are assumed to reach a steady state temperature. Next, on the chip that is instrumented to measure temperature, the frequency is increased in increments with sufficient time after each increase for the temperature to reach a steady state. A record of this data establishes the way in which temperature varies with frequency. When a frequency is sufficiently high that detectible errors occur, compromising hashrate, this is considered a “fail frequency” frail and the measured temperature considered the fail temperature, Trail. In some implementations, errors may be detected by monitoring a machine's logs for error messages or by measuring a decline in a machine's hashrate.

Even though chip temperatures may not be available for non-instrumented chips in a machine, a similar approach can be used to infer a temperature for the non-instrumented chips. For the non-instrumented chips in the machine, on one chip at a time and while holding all other chips at the nominal frequency, the frequency on the designated chip is increased in gradual steps until a detectible error is obtained, establishing the maximum frequency, frail, for that specific chip. That is the best available estimate for the maximum frequency for that chip, but it is a number that can be further refined. No two chips are exactly the same, so some variation in both temperature rise and the frequency at which errors occur is expected.

It is important to stress that many status quo machines have an ability to optimize locally. One improvement described by the present disclosure is a framework for optimizing performance through remote tuning of individual chips. A remote tuning interface, which may be utilized using a GUI, command line, or other means, allows the previously described process to be performed on both individual machines and a large number of machines. The remote tuning interface can permit functionality present in general ASIC management software in addition to newly enhanced functionally for remotely tuning groups of machines. In some implementations, the remote tuning interface can provide a “library” of different “tuning profiles” to push to machines. “Tuning profiles” can be created by various users (for example, an entity owning multiple miner data centers/equipment or submitted by users that are permitted to use miners in the data centers). Tuning a chip yields a probability distribution for T_{fail} in terms of f_{fail}. Thus, temperature of non-instrumented chips can be estimated based on the temperature of instrumented chips with a known probability.

Furthermore, using this data for many machines can allow production of a “heat map” for all chip locations to show how much on-average the temperature of a particular chip location varies with respect to instrumented chips.

Note that this process allows tuning to account for differences in individual chipsets, manufacturing differences and locations within the machine. The choice of operating frequency can then be very specific to the individual machine, although other machines of similar construction will likely have similar profiles. Machine operators can then choose operating frequencies that are a specific fraction of the maximum across all chips in a machine so that hashrate can be optimized. By adjusting this fraction of the maximum frequency, machine longevity can also be addressed. Lower frequency fractions mean less generated heat, lower operating temperatures and longer life. Higher frequency fractions mean higher hash rates, but also associated higher temperatures.

Further features of the described improvement its nature and various advantages will be more apparent from the accompanying drawings and further description of preferred embodiments.

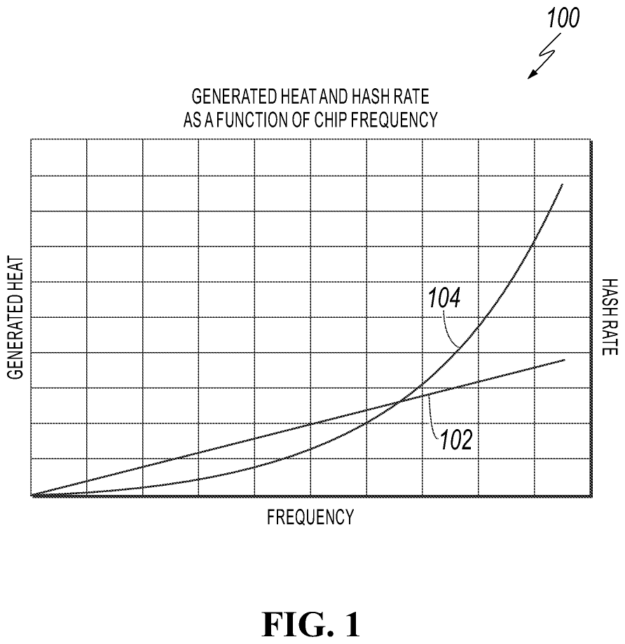

FIG. 1 is a graph 100 depicting a plot of generated heat and hashrate vs frequency, according to an implementation of the present disclosure.

As illustrated, hashrate 102 is shown to be approximately linear with respect to chip frequency. However, the generated heat 104 increases at an exponential rate with respect to chip frequency. There is a cost associated with excessive heat as it can lead to premature failure of the chip. Accordingly, an operator of machines is required to balance the benefit of higher hashrate that accrues from higher chip frequencies with the cost of potential damage that could occur from excessive heat.

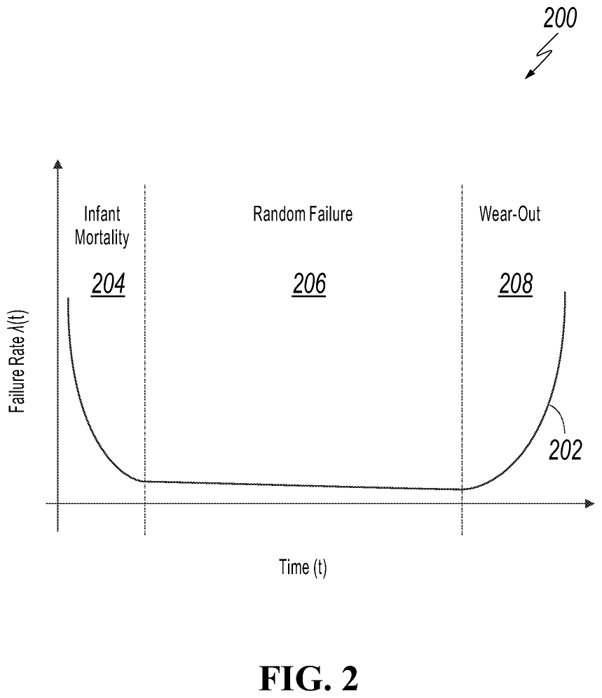

FIG. 2 is a graph 200 depicting failure rate for a complicated system as a function of time, according to an implementation of the present disclosure.

FIG. 2 depicts a curve 202 for the failure rate of complicated systems as a function of time. This is similar to a known “bathtub curve” previously developed by actuaries to analyze life expectancy and widely used by electronics manufacturers. There are three distinct regions in the life of a complicated electronic system, such as a chip used for cryptocurrency mining. During the initial region 204, manufacturing errors or failure prone components are most likely to become known. This is the “infant mortality” region and is typically addressed by the manufacturer through a test and burn-in process before the product is released. Once in the field, the unit operates in a satisfactory manner with a low probability of failure. This is the region denoted as 206. Over time, components and subcomponents age or begin to wear out and this leads to a higher rate of failure toward component end-of-life 208. FIG. 2 is illustrative for a given operating condition. The actual curve experienced by any single device or collection of devices will be dependent upon operating conditions such as temperature, duty cycle of operation, and other factors.

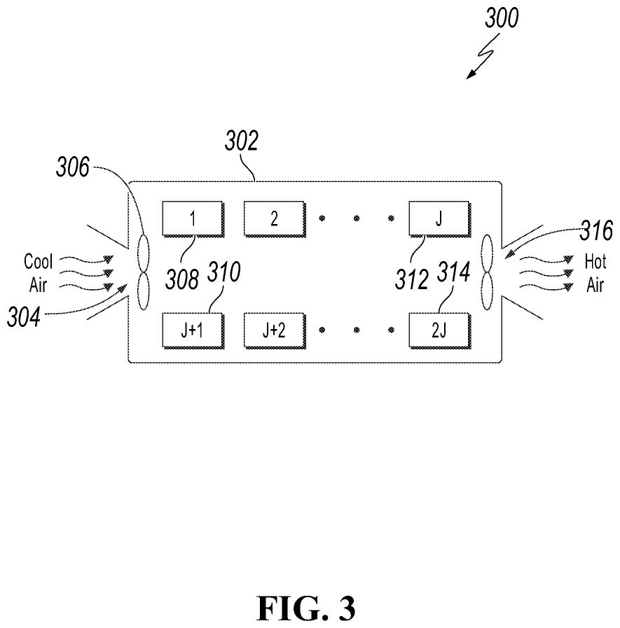

FIG. 3 is a block diagram 300 depicting the airflow in a representative machine 302 having 2J chips, according to an implementation of the present disclosure.

In the illustrated implementation, each chip represents a complete processing unit that is capable of solving a cryptographic puzzle in parallel with all other chips in the machine 302. Cool air is drawn into the air intake 304 of the machine 302 by a fan 306. Chips 308 and 310 are located near the air intake 304 while chips 312 and 314 are located near the air exhaust 316. Cooling is critical for the chips in a machine, since they generate significant heat when they are operated at a high frequency. Each chip will attain a steady state temperature when the waste heat energy that is generated by that chip is exactly offset by the heat energy that is removed from that chip. If there is an imbalance, then the temperature will change. It is important to avoid overtemperature conditions in the chips in a machine. Air cooling is one approach. Cool air is drawn into the machine 302 through air intake 304. As it passes across the chips in the machine 302, possibly directed by air baffles and louvers, heat generated by the chips is transferred to the air. This causes the air to increase in temperature, making it less effective in cooling subsequent chips that it encounters. Finally, the now hot air leaves the machine 302 through air exhaust 316. It is important to note that in FIG. 3, chips 308 and 310 are near the air intake 304 and so they will receive relatively cooler air, which is better able to remove heat from chips 308 and 310. But as air moves through the machine, it increases in temperature as it cools the chips that it passes by. As the air nears the air exhaust 316 it is at its highest temperature from its journey through the machine 302 and has the lowest capacity to cool chips 312 and 314. Chips 308 and 310 which are near the cool end of machine 302 are likely to run at a lower temperature than chips 312 and 314 when operating in an otherwise identical manner. This means that chips 312 and 314 are likely to fail prematurely relative to chips 308 and 310. Alternatively, in some implementations, chips 312 and 314 can be operated with a reduced frequency relative to chips 308 and 310 in order to avoid premature failure.

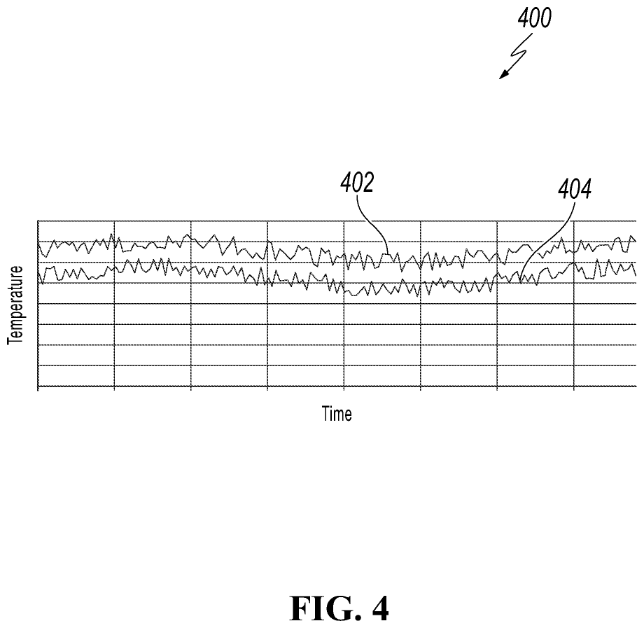

FIG. 4 is a graph 400 depicting possible temperature profiles over time for two chips in a machine, according to an implementation of the present disclosure.

In order to characterize the difference in operating performance, a historical record of operations over an extended period is recorded for the two chips while they are being operated in an identical manner. The only variable is the chip location. Plot 402, which corresponds to the first chip, demonstrates a higher general temperature than plot 404, which is for the second chip. The chip corresponding to plot 402 might have a higher temperature because it was located near the air exhaust of the machine, and so it is being cooled with air that has been heated. Or, the chip corresponding to plot 402 might be located in a position where air flow is restricted relative to the chip represented by plot 404. By adjusting fan flow, a set of curves to contrast the heating differences between two chips can be developed. With low levels of air movement, both chips would be expected to rise substantially in temperature with perhaps less of a temperature difference since air flow would be less impactful on chip temperature. While existing machines are designed with fans that are meant to cool chips and other internal components on a collective basis, future machines may be designed with ventilation systems in which there is a dedicated cooling mechanism for each chip or internal component. In that case, an implementation of the present disclosure could be used to adjust the dedicated cooling mechanisms so that all components perform at an optimal level, independent from whether some components receive cooling at a higher or lower temperature.

While FIG. 4 provides a visual presentation of the difference between the temperature profiles of two chips, a more practical approach is to use statistical tools to characterize the two profiles. One of the most useful statistical tools is the sample mean defined as:

$$μ = \frac{1}{N} {\sum }_{i = 1}^{N} {T}_{i} ,$$

where there are N data points and Tᵢ is the i^{th} temperature measurement. This allows a straightforward contrast between two plots through comparison of the sample means.

Using the temperature profiles as a guide, an operator can choose to adjust frequency for all chips in a given machine in such a way that all chips experience a uniform temperature rise. This can lead to a higher overall hashrate for the machine as a whole by having well-ventilated chips operating at a higher frequency while less ventilated chips can be controlled to avoid thermal runaway. The process would likely be iterative and might need to be performed periodically throughout the life of a given machine as components age. An important improvement over current practice is that this adjustment is performed dynamically and remotely and can take advantage of historical information. In particular, historical information on balancing the performance of other machines that might have similar construction and that could have performance optimized with a similar approach is very useful.

In currently existing machines, chip temperature of all chips is estimated from either a single instrumented chip or even from the board temperature. This has the negative effect that some of the chips may run at a lower temperature than an allowed limit, thereby giving up potential hashrate, while other chips may run at a higher temperature than intended, giving up longevity. In the proposed improvement, as detailed above, chip temperature can be estimated far more accurately, thereby increasing either hashrate, machine longevity, or both.

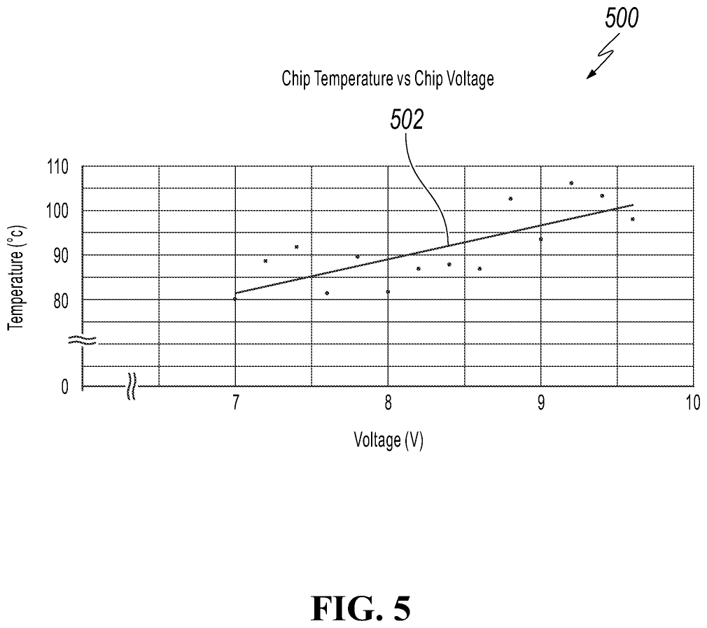

FIG. 5 is a plot 500 depicting chip temperature vs chip voltage, according to an implementation of the present disclosure.

The individual data points can be seen to be positively correlated since as chip voltage increases, on average, the chip temperature is seen to increase. In contrast, and not shown, if an increase in chip voltage led to a decrease in chip temperature, the two variables would be said to be negatively correlated. If there is no discernable relationship, then the variables are said to be uncorrelated.

A linear fit (for example, around line 502) can be helpful in determining the type of correlation, either positive, negative, or zero. Line 502 could be derived as a least squares fit of the data points or by other means, but in general, the line is not as helpful for data analysis as a statistical quantity known as Pearson's correlation coefficient, ρ (a number between −1 and +1). If ρ=0, then the two variables are uncorrelated. If ρ is positive, then the two variables are positively correlated. If ρ is negative, the variables are negatively correlated. Magnitude of ρ indicates a degree of scatter of the points around a linear fit. With higher values, the points are closer to a linear fit (for example, a linear fit illustrated around line 502). If the magnitude is lower, then the points are more widely scattered away from line 502.

A time record of operational data from a collection of chips can be stored. This database can then be analyzed and used to improve machine performance. Using correlation to analyze this data allows an operator to identify relationships that may not be obvious over a limited data set but become evident over time. The operational data is unique to each chip and can be considered to be a unique fingerprint that identifies: 1) unchanging system characteristics, such as chip type, machine type and date of manufacture; 2) inputs such as chip frequency, board voltage, and fan speed; 3) environmental factors such as the temperature, humidity and particulate count of the machine intake air; and 4) outputs, such as hashrate and chip temperature. Correlations between variables of interest can be used for diagnostic analysis to optimize performance and to anticipate failures.

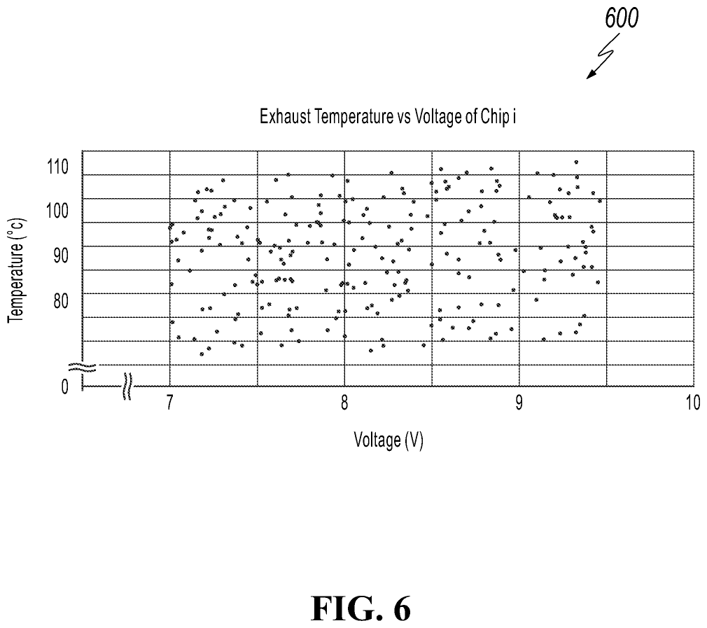

FIG. 6 is a scatter plot 600 depicting the exhaust temperature from a machine versus the voltage setpoint for a specific chip, i, inside that machine, according to an implementation of the present disclosure.

From inspection, the slope appears to be close to zero, suggesting that the two variables are uncorrelated. However, with a large amount of data, a statistical analysis can provide better insight than a visible inspection. For this example, a correlation coefficient can be defined between exhaust temperature and voltage as:

$${ρ}_{te} = \frac{cov ( t , v )}{{σ}_{t} {σ}_{v}} ,$$

where cov(t,e) is the sample covariance between exhaust temperature and chip i voltage given by:

$$cov ( t , v ) = \frac{1}{N - 1} {\sum }_{n = 1}^{N} [ ( {t}_{n} - {μ}_{t} ) ( {v}_{n} - {μ}_{v} ) ] ,$$

where there are N data points, tₙ is the n^{th} value of exhaust temperature, vₙ is the n^{th} value of chip voltage, and μₜ and μᵥ are, respectively, the sample means of temperature and voltage. The sample standard deviations of temperature and voltage are calculated as:

$${σ}_{t} = \sqrt{\frac{1}{N - 1} {\sum }_{n = 1}^{N} {( {t}_{n} - {μ}_{t} )}^{2}} ,$$

$$and$$

$${σ}_{v} = \sqrt{\frac{1}{N - 1} {\sum }_{n = 1}^{N} {( {v}_{n} - {μ}_{v} )}^{2}} .$$

When this statistical analysis is applied to the data depicted in FIG. 6, the resultant correlation coefficient is 0.016. That suggests a positive correlation but the magnitude is so small that it would be surmised that when increased voltage is applied to chip i, it serves to increase exhaust temperature (which is reasonable) but only by a small amount (also reasonable).

One of ordinary skill in the art will realize that there are many possible relationships that can be analyzed using statistical tools. For example, pairs of variables can be analyzed using the analysis described above. Or multivariate analysis can be implemented where a given dependent variable can be analyzed as a function of multiple independent variables to determine which inputs to a system have a significant impact on a given output, which inputs are less important, and which inputs are irrelevant. This can serve as a tool for using a huge database of historical data to optimize for a given performance objective.

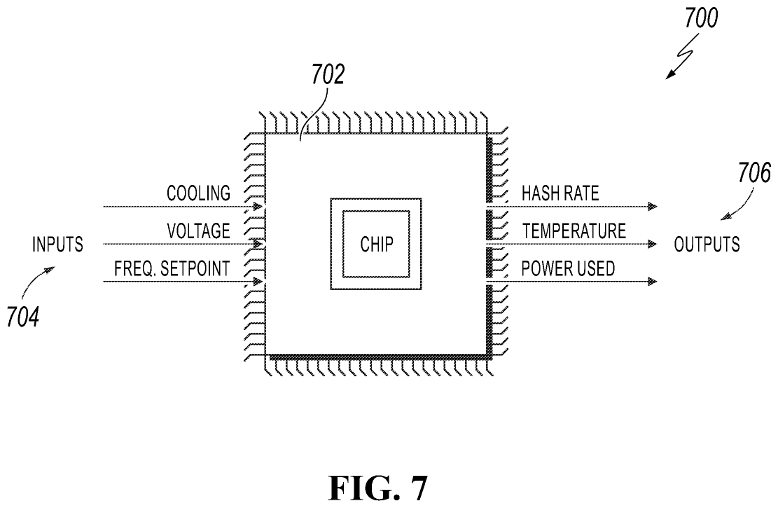

FIG. 7 is a block diagram 700 depicting a single complete processing unit or “chip” used in a machine, according to an implementation of the present disclosure.

A typical machine might have 200 or more such chips, each of which can operate independently of the other chips in the machine. Chip 702 has inputs 704 that govern performance. These inputs include a voltage, a frequency setpoint and cooling. Of these inputs, voltage and frequency setpoints will have a range of discrete values and are completely controllable by a potentially remote operator. Cooling might be partially controllable by an operator, for example by managing air flow using an exhaust fan setting. But cooling will also be subject to environmental factors that might be outside of an operator's control, such as ambient temperature or ambient humidity. The outputs 706 from a chip 702 include the power usage, the temperature at some point within the chip 702 and the hashrate, which is an important performance metric that expresses the effectiveness of the chip 702 in evaluating solutions to the underlying cryptopuzzle.

An operator can experiment with different inputs 704 to achieve a specific performance objective. For example, an operator might try a fixed voltage and then gradually increase the frequency setpoint, monitoring the hashrate of the chip. When hashrate no longer increases with frequency (or stops altogether) then this establishes a frequency limit given the voltage and cooling inputs. This process is laborious. The operation of a chip while testing it for the limits of performance is necessarily compromised and so testing has a cost.

By capturing a time history of the inputs 704 and outputs 706 of chip 702, the health of chip 702 can be inferred and this information can be used to manage the operation of the chip 702. All electronic components will experience aging through use as electrochemical processes take place. This aging is accelerated at higher temperatures. Accordingly, knowledge of how chip 702 has been operated over its lifetime can be used to formulate an appropriate control strategy to achieve a given performance objective. Furthermore, if chip 702 is found to fail or to experience reductions in performance, the historical record of how chip 702 was operated allows the operator to analyze the conditions that led to reductions and to act to mitigate reductions in performance.

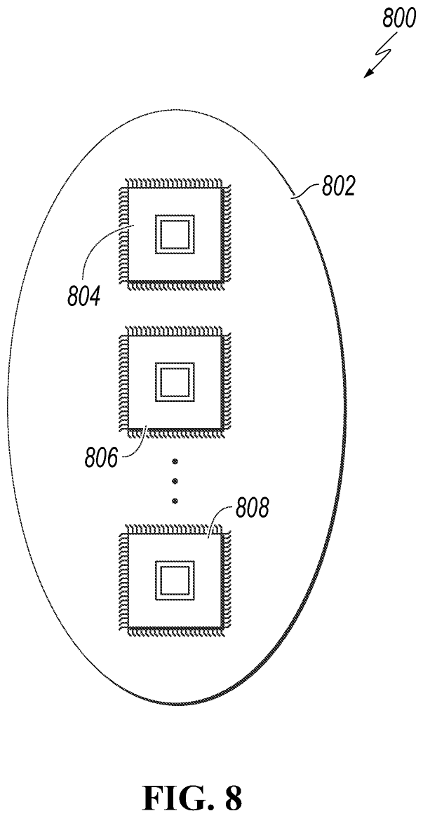

FIG. 8 is a block diagram 800 depicting a collection of chips in a collection of machines such as at one farm 802, according to an implementation of the present disclosure.

All machines at the farm 802 and, consequently every chip from the machines at the farm, will be used to solve the same blockchain cryptopuzzles. A farm might consist of 1,000 or more machines, each of which has 200 or more chips. So, a farm might have 200,000 chips. FIG. 8 depicts the collection of chips in a farm with N chips, where N might be 200,000 or more. Chip 1 804 could be physically located in a very distant location from chip 2 806 but all chips in the farm 802 are networked and can be controlled individually. The chips in the farm, for example, including chip N 808, need not be of the same construction, brand, manufacturing date or location within an individual machine. Along with a time history of performance, this information represents “state information” since it defines the state of the individual chip. Having a farm with many chips allows an operator an opportunity to apply data analytics to optimize performance.

One advantage to using data analytics is that an operator can group chips into like categories and perform an analysis on a sample of each category to determine operational setpoints for all the members of that category. For example, suppose that there are 500 chips within a farm that are of the same model and are located in identical positions within their respective machines. Analyzing one chip in this subset can inform the optimal way to operate the remaining chips in the subset. While the analysis might require testing the chip to failure or programming it to execute at a low frequency setpoint, which would reduce overall performance of the subset, this can be outweighed by the lessons learned that will allow for the optimization of the other chips in the sub set.

A second advantage for using data analytics is that a historical database of like chip categories can be maintained. The historical database can be analyzed to understand chip and machine health and to implement proactive measures. If any given chip fails or experiences a degradation in performance, then the historical database can be examined for factors leading up to failure to understand the underlying causes. This information could then guide the choice of operating setpoints for other members of the category in order to prevent premature failure.

A third advantage for using data analytics for optimization is that testing can be an ongoing process, spread out among the individual chips in a collection of chips. For example, since temperature hotspots are not desirable, a farm operator might implement a thermal balancing experiment on a single machine within the farm, adjusting the voltage and/or frequency setpoints for each chip within the machine in order to achieve a local (to the machine) objective of a balanced thermal load. The end objective would be to control the frequency of each chip in that machine so that the temperatures are uniform for all chips within the machine. Then by increasing frequency proportionally, the temperature should increase but still be balanced. An alternative approach would be to reduce the frequency, or downclock, select chips in a given machine while upclocking the frequency of other chips within the same machine and then alternating the process. Since thermal runaway is a concern, where increased temperature results in reduced efficiency which leads to excessive waste heat, it is possible that this approach could lead to an overall higher performance when compared to simply operating all chips with unchanging frequency. Testing could be spread over many machines in a farm. Lessons learned from one machine could be applied to all machines.

The foregoing is intended to be illustrative of the principles of the described improvement, and various modifications can be made by those skilled in the art without departing from the scope and spirit of the described approach.

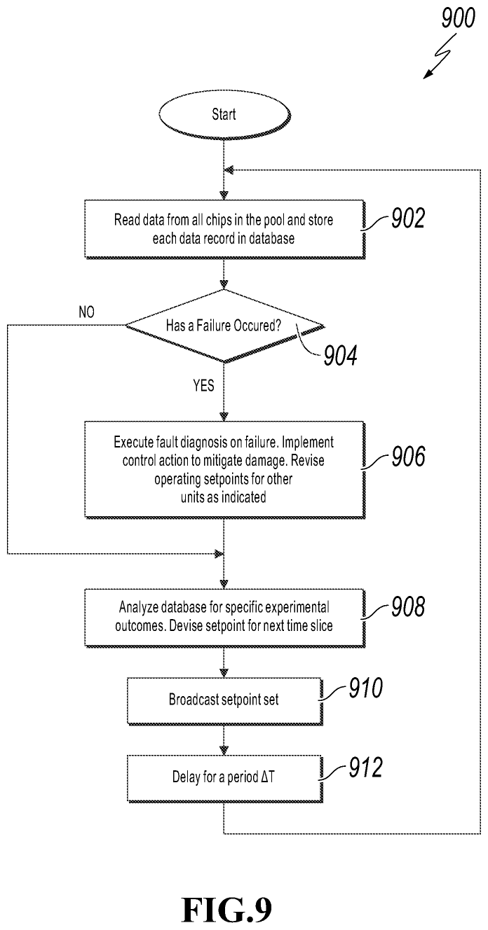

FIG. 9 is a flowchart 900 illustrating an example of a computer-implemented method for dynamically optimizing the performance of a machine, according to an implementation of the present disclosure.

At step 902, the current data from all chips is read and stored as a database entry. Each time stamped data record would have information that identifies the particular chip, its location, manufacturing particulars, environmental information as available including ambient temperature and humidity, operating setpoints of voltage and frequency and outputs such as hashrate and power used.

Next, in step 904, the hashrate from each chip is analyzed to see if it lies within an expected range. If the hashrate is low or zero, this is indicative of a chip failure and the chip must be analyzed for the failure reason.

In step 906, the historical record corresponding to the failed chip can be inspected to identify any warning signs that predicted the failure. A control action to bring any malfunctioning chips back into service will be determined. Any database conclusions that predicted the failure will be compared to the databases for other chips to determine control actions that will prevent similar failures.

Next, in step 908, the database will be used to devise one or more experiments. It should be noted that a database is an extremely valuable tool in allowing the segregation of data into groups. Every chip will belong to multiple groups. For example, a chip of type X that is in position Y (for example, the leftmost position next to the air intake) in a machine of type Z belongs to the Group X, the Group Y and the Group Z. This allows the analysis of, for example, temperature rise in group Z as a function of frequency setpoint or an analysis of hashrate for chips belonging to X, Y, and Z when voltage has a certain value.

In the next step 910, setpoint changes will be broadcast to some or all of the chips in the collection of chips. Setpoints include items like chip voltage, chip frequency and fan speed.

In the next step 912, a delay of ΔT will be implemented. Chip management will be a discrete exercise since outcomes will not change instantaneously and since there is a software overhead associated with changing parameters. In one example, a typical value of ΔT might be on the order of 10 minutes.

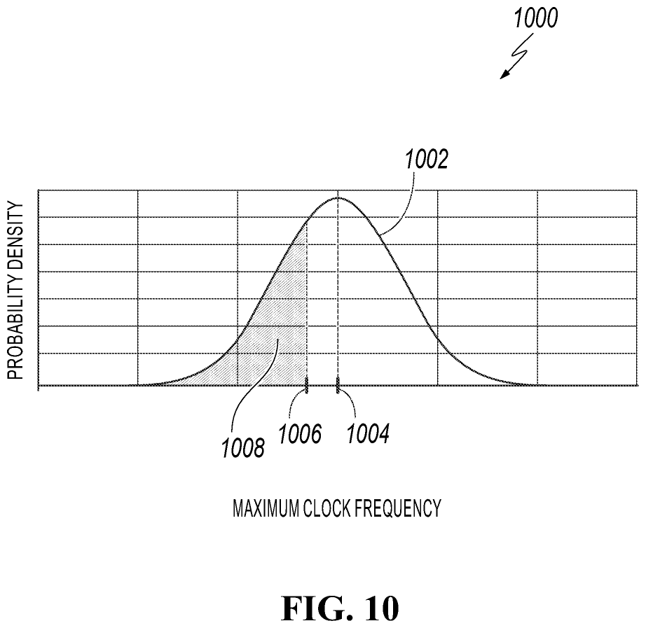

FIG. 10 is a graph 1000 depicting a probability density 1002 for the maximum clock frequency for a large collection of identical chips at a fixed temperature, according to an implementation of the present disclosure.

Even though the curve of probability density 1002 is depicted as a continuous curve, in reality it is derived as a histogram of the chips under test showing the number of chips having a maximum clock frequency lying between different frequency ranges. With large numbers of measurements, such a histogram approaches a continuous curve and so a continuous curve can be used as the basis for this discussion without loss of generality. The maximum clock frequency is defined as the frequency at which a chip can produce the highest hashrate. Operating a chip at a frequency that is lower than the maximum clock frequency results in a lower hashrate. Operating a chip at a frequency higher than the maximum clock frequency results in “glitchy” performance (due to the chip operating improperly) and a corresponding roll-off in the hashrate. Operating a chip at the maximum clock frequency may result in an occasional glitch, where work in progress on a certain trial solution may have to be restarted. There is a trade-off between higher frequencies, which generally lead to a higher hashrate and glitches which reduce the hashrate.

The shape of the probability density depicted in FIG. 10 is known as a Gaussian or normal distribution and commonly arises when statistically analyzing a large collection of measurements from identical processes. All Gaussian curves have an area under the curve of 1 and the same general shape and are completely characterized by two numbers, the mean and the standard deviation.

In FIG. 10 the mean 1004 is the frequency for which exactly half of the chips have a maximum clock frequency that is less than the mean 1004 and exactly half of the chips have a maximum frequency that is greater than the mean 1004. The standard deviation is a number that characterizes the tendency for measurements to be close to the mean. For small standard deviations, the Gaussian curve will be tall and narrow. For any given frequency 1006 on the x-axis, the percentage of chips which have a maximum frequency of that value or lower corresponds to the area 1008 under the curve to the left of the given frequency 1006.

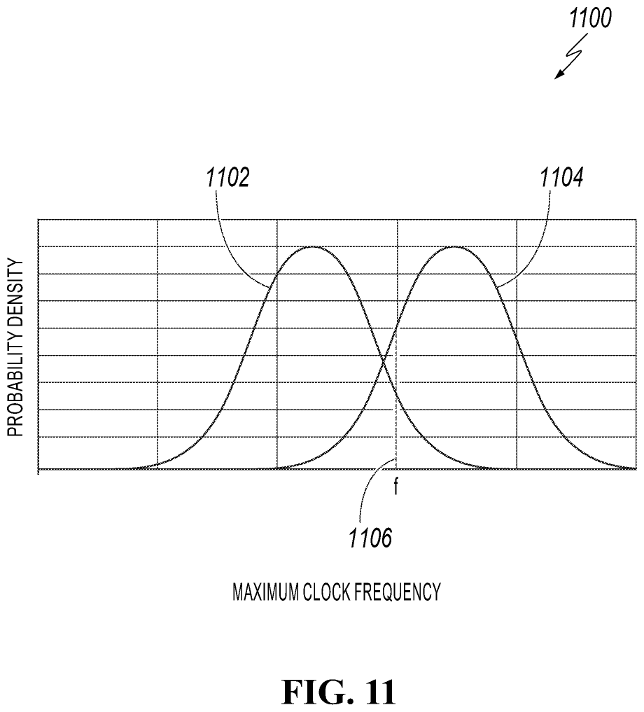

FIG. 11 is a graph 1100 depicting the probability density for the maximum clock frequency for a collection of identical chips under two different temperature scenarios, according to an implementation of the present disclosure.

Any given electronic circuit within a chip is more likely to fail at higher temperatures. Since a chip is constructed from millions of electronic circuits, a given chip is statistically likely to exhibit a lower maximum clock frequency when the temperature is higher. In FIG. 11, the Gaussian curve 1102 corresponds to the probability density for maximum clock frequency for chips when operating at temperature T₁ and the curve 1104 corresponds to a lower relative temperature, T₂, where T₂<T₁. If a collection of identical chips is operated at some arbitrary clock frequency, f, 1106, then for chips operating at a temperature of T₂, the majority will have glitch-free operation. This is because the area under the curve 1104 to the right of the frequency f, 1106 is relatively large, so most chips at temperature T₂ have a maximum clock frequency greater than f. In contrast, for chips operating at a temperature of T₁, the majority will experience glitchy operation at frequency f because the area under Gaussian curve 1102 to the right of 1106 is relatively small. It should be noted that the two curves in FIG. 11 are shown as having the same standard deviation. That is, the two curves having the same height of their peaks and the same width when measured at a common cross-section. In reality, the two curves would most likely have different standard deviations.

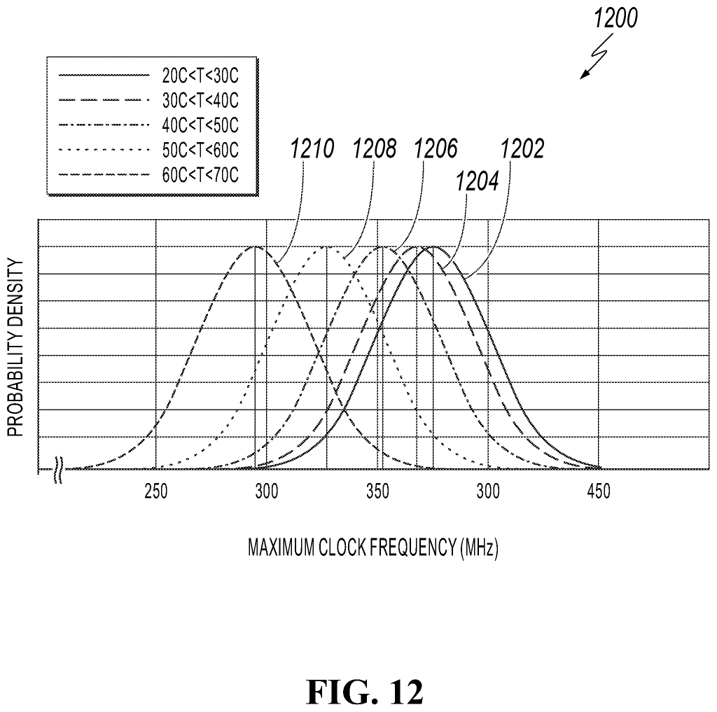

As a specific example of the use of the concept of probability density for the remote optimization of a mining farm, consider the case of 1,000 machines of identical construction, each of which has one chip that is instrumented to measure temperature. Under remote control, all 1,000 chips are gradually increased in clock frequency. The increase might be, for example, in increments of 5 MHz, starting from 250 MHz. With each increment, sufficient time is allowed to pass for the chip to reach a steady state operating condition. Then the hashrate and temperature is measured. For a chip, when hashrate reaches a maximum, the corresponding clock frequency is noted as the maximum clock frequency for that chip. The process continues until the maximum clock frequency is determined for all 1,000 temperature instrumented chips. The temperature of a given chip will be a function of external factors such as external cooling as well as internally generated heat which will increase with clock frequency. By collecting data under different operating conditions, a data record of many thousands of measurements for the temperature instrumented chips can be collected. That data can then be used to generate a set of plots like the one shown in FIG. 12.

FIG. 12 is a graph 1200 depicting probability densities for the maximum clock frequency of a collection of chips under different temperature operating conditions, according to an implementation of the present disclosure.

A collection of measurements is sorted according to the measured temperature. By plotting the number of units exhibiting a maximum clock frequency in each temperature range a family of curves can be derived. The rightmost curve 1202 corresponds to maximum clock frequency determinations that were obtained for units operating at a temperature between 20° C. and 30° C. The next curve 1204 corresponds to temperatures between 30° C. and 40° C. and illustrates a slight decrease in maximum clock frequency compared to curve 1202, which is expected due to the higher operating temperature. In the same way, curve 1206, corresponding to the range 40° C.-50° C., curve 1208, corresponding to the range 50° C.-60° C. and curve 1210, corresponding to the range 60° C.-70° C. each demonstrate progressive decreases in maximum clock frequency.

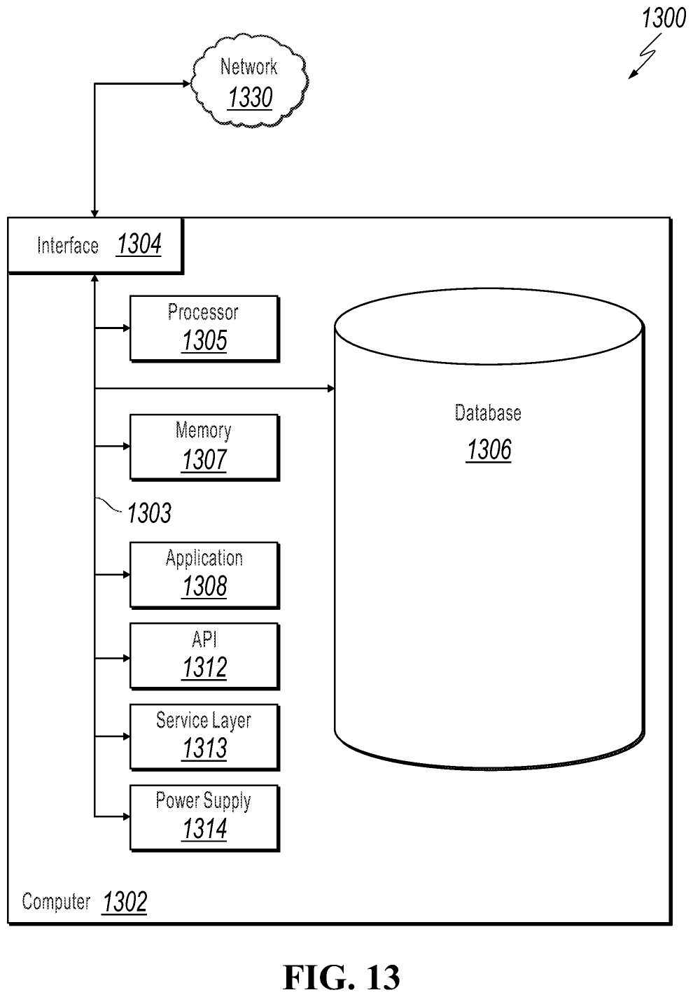

FIG. 13 is a block diagram illustrating an example of a computer-implemented System 1300 used to provide computational functionalities associated with described algorithms, methods, functions, processes, flows, and procedures, according to an implementation of the present disclosure.

In the illustrated implementation, System 1300 includes a Computer 1302 and a Network 1330. The illustrated Computer 1302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1302 can include an input device, such as a keypad, keyboard, or touch screen, or a combination of input devices that can accept user information, and an output device that conveys information associated with the operation of the Computer 1302, including digital data, visual, audio, another type of information, or a combination of types of information, on a graphical-type user interface (UI) (or GUI) or other UI.

The Computer 1302 can serve in a role in a distributed computing system as, for example, a client, network component, a server, or a database or another persistency, or a combination of roles for performing the subject matter described in the present disclosure. The illustrated Computer 1302 is communicably coupled with a Network 1330. In some implementations, one or more components of the Computer 1302 can be configured to operate within an environment, or a combination of environments, including cloud-computing, local, or global.

At a high level, the Computer 1302 is an electronic computing device operable to receive, transmit, process, store, or manage data and information associated with the described subject matter. According to some implementations, the Computer 1302 can also include or be communicably coupled with a server, such as an application server, e-mail server, web server, caching server, or streaming data server, or a combination of servers.

The Computer 1302 can receive requests over Network 1330 (for example, from a client software application executing on another Computer 1302) and respond to the received requests by processing the received requests using a software application or a combination of software applications. In addition, requests can also be sent to the Computer 1302 from internal users (for example, from a command console or by another internal access method), external or third-parties, or other entities, individuals, systems, or computers.

Each of the components of the Computer 1302 can communicate using a System Bus 1303. In some implementations, any or all of the components of the Computer 1302, including hardware, software, or a combination of hardware and software, can interface over the System Bus 1303 using an application programming interface (API) 1312, a Service Layer 1313, or a combination of the API 1312 and Service Layer 1313. The API 1312 can include specifications for routines, data structures, and object classes. The API 1312 can be either computer-language independent or dependent and refer to a complete interface, a single function, or even a set of APIs. The Service Layer 1313 provides software services to the Computer 1302 or other components (whether illustrated or not) that are communicably coupled to the Computer 1302. The functionality of the Computer 1302 can be accessible for all service consumers using the Service Layer 1313. Software services, such as those provided by the Service Layer 1313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1302, alternative implementations can illustrate the API 1312 or the Service Layer 1313 as stand-alone components in relation to other components of the Computer 1302 or other components (whether illustrated or not) that are communicably coupled to the Computer 1302. Moreover, any or all parts of the API 1312 or the Service Layer 1313 can be implemented as a child or a submodule of another software module, enterprise application, or hardware module without departing from the scope of the present disclosure.

The Computer 1302 includes an Interface 1304. Although illustrated as a single Interface 1304, two or more Interfaces 1304 can be used according to particular needs, desires, or particular implementations of the Computer 1302. The Interface 1304 is used by the Computer 1302 for communicating with another computing system (whether illustrated or not) that is communicatively linked to the Network 1330 in a distributed environment. Generally, the Interface 1304 is operable to communicate with the Network 1330 and includes logic encoded in software, hardware, or a combination of software and hardware. More specifically, the Interface 1304 can include software supporting one or more communication protocols associated with communications such that the Network 1330 or hardware of Interface 1304 is operable to communicate physical signals within and outside of the illustrated Computer 1302.

The Computer 1302 includes a Processor 1305. Although illustrated as a single Processor 1305, two or more Processors 1305 can be used according to particular needs, desires, or particular implementations of the Computer 1302. Generally, the Processor 1305 executes instructions and manipulates data to perform the operations of the Computer 1302 and any algorithms, methods, functions, processes, flows, and procedures as described in the present disclosure.

The Computer 1302 also includes a Database 1306 that can hold data for the Computer 1302, another component communicatively linked to the Network 1330 (whether illustrated or not), or a combination of the Computer 1302 and another component. For example, Database 1306 can be an in-memory or conventional database storing data consistent with the present disclosure. In some implementations, Database 1306 can be a combination of two or more different database types (for example, a hybrid in-memory and conventional database) according to particular needs, desires, or particular implementations of the Computer 1302 and the described functionality. Although illustrated as a single Database 1306, two or more databases of similar or differing types can be used according to particular needs, desires, or particular implementations of the Computer 1302 and the described functionality. While Database 1306 is illustrated as an integral component of the Computer 1302, in alternative implementations, Database 1306 can be external to the Computer 1302. The illustrated Database 1306 can store, process, and supply any data type consistent with this disclosure.

The Computer 1302 also includes a Memory 1307 that can hold data for the Computer 1302, another component or components communicatively linked to the Network 1330 (whether illustrated or not), or a combination of the Computer 1302 and another component. Memory 1307 can store any data consistent with the present disclosure. In some implementations, Memory 1307 can be a combination of two or more different types of memory (for example, a combination of semiconductor and magnetic storage) according to particular needs, desires, or particular implementations of the Computer 1302 and the described functionality. Although illustrated as a single Memory 1307, two or more Memories 1307 or similar or differing types can be used according to particular needs, desires, or particular implementations of the Computer 1302 and the described functionality. While Memory 1307 is illustrated as an integral component of the Computer 1302, in alternative implementations, Memory 1307 can be external to the Computer 1302.

The Application 1308 is an algorithmic software engine providing functionality according to particular needs, desires, or particular implementations of the Computer 1302, particularly with respect to functionality described in the present disclosure. For example, Application 1308 can serve as one or more components, modules, or applications. Further, although illustrated as a single Application 1308, the Application 1308 can be implemented as multiple Applications 1308 on the Computer 1302. In addition, although illustrated as integral to the Computer 1302, in alternative implementations, the Application 1308 can be external to the Computer 1302.

The Computer 1302 can also include a Power Supply 1314. The Power Supply 1314 can include a rechargeable or non-rechargeable battery that can be configured to be either user- or non-user-replaceable. In some implementations, the Power Supply 1314 can include power-conversion or management circuits (including recharging, standby, or another power management functionality). In some implementations, the Power Supply 1314 can include a power plug to allow the Computer 1302 to be plugged into a wall socket or another power source to, for example, power the Computer 1302 or recharge a rechargeable battery.

There can be any number of Computers 1302 associated with, or external to, a computer system containing Computer 1302, each Computer 1302 communicating over Network 1330. Further, the term “client,” “user,” or other appropriate terminology can be used interchangeably, as appropriate, without departing from the scope of the present disclosure. Moreover, the present disclosure contemplates that many users can use one Computer 1302, or that one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for processing unit configuration, comprising:
collecting a first set of operational data from each processing unit of one or more processing units during a first time period;
modifying, based on the first set of operational data, one or more operational parameters of the one or more processing units;
dynamically configuring the one or more processing units based on the one or more operational parameters;
collecting a second set of operational data from each processing unit of the one or more processing units during a second time period;
determining, using at least one metric, at least one change in performance of the one or more processing units based on a comparison of the first set of operational data and the second set of operational data;
determining a modified configuration based on the change in performance; and
configuring the one or more processing units for operation based on the modified configuration.

2. The computer-implemented method of claim 1, comprising:
sequentially pushing the one or more processing units to an extreme operating point; and
determining state information of the one or more processing units when the one or more processing units are at the extreme operating point.

3. The computer-implemented method of claim 2, wherein the state information includes one or more of maximum clock frequency, temperature, power used, minimum necessary voltage and efficiency.

4. The computer-implemented method of claim 2, wherein the extreme operating point includes one or more of frequency setpoint, voltage setpoint, ventilation, and ambient conditions.

5. The computer-implemented method of claim 1, wherein measurements of temperature are used to control a frequency of operation of the one or more processing units.

6. The computer-implemented method of claim 1, wherein statistical methods are used to identify correlations between variables by analyzing a large number of measurements from a given processing unit.

7. The computer-implemented method of claim 1, wherein statistical methods are used to identify correlations between variables by analyzing a large number of measurements from multiple processing units.

8. The computer-implemented method of claim 1, wherein:
at least one of (i) the first set of operational data or (ii) the second set of operational data comprises current costs for a unit of energy; or
at least one of (i) the first set of operational data or (ii) the second set of operational data comprises a type of an energy source that powers the one or more processing units.

9. A non-transitory, computer-readable medium storing one or more instructions executable by a computer system to perform one or more operations for processing unit configuration, comprising:
collecting a first set of operational data from each processing unit of one or more processing units during a first time period;
modifying, based on the first set of operational data, one or more operational parameters of the one or more processing units;
dynamically configuring the one or more processing units based on the one or more operational parameters;
collecting a second set of operational data from each processing unit of the one or more processing units during a second time period;
determining, using at least one metric, at least one change in performance of the one or more processing units based on a comparison of the first set of operational data and the second set of operational data;
determining a modified configuration based on the change in performance; and configuring the one or more processing units for operation based on the modified configuration.

10. A computer-implemented system for processing unit configuration, comprising:
one or more computers; and
one or more computer memory devices interoperably coupled with the one or more computers and having tangible, non-transitory, machine-readable media storing one or more instructions that, when executed by the one or more computers, perform one or more operations, comprising:
collecting a first set of operational data from each processing unit of one or more processing units during a first time period;
modifying, based on the first set of operational data, one or more operational parameters of the one or more processing units;
dynamically configuring the one or more processing units based on the one or more operational parameters;
collecting a second set of operational data from each processing unit of the one or more processing units during a second time period;
determining, using at least one metric, at least one change in performance of the one or more processing units based on a comparison of the first set of operational data and the second set of operational data;
determining a modified configuration based on the change in performance; and
configuring the one or more processing units for operation based on the modified configuration.

11. A computer-implemented method for processing unit configuration, comprising:
collecting a first set of operational data of a first set of one or more components of a plurality of components based on one or more measurements performed using one or more sensors associated with the first set of one or more components; and
estimating a second set of operational data of a second set of one or more components different from the first set of one or more components based on the first set of operational data.

12. The computer-implemented method of claim 11, comprising:
determining a correlation of operational data between at least one component of the first set of one or more components and at least one component of the second set of one or more components.

13. The computer-implemented method of claim 12, comprising:
determining, as a determined correlation, a configuration for operating the second set of one or more components based on the determined correlation.

14. The computer-implemented method of claim 11, comprising:
determining, from at least one of (i) the first set of operation data or (ii) the second set of operational data, an incipient failure of any one or more of the first set of one or more components or the second set of one or more components, respectively.

15. The computer-implemented method of claim 11, wherein the computer-implemented method is performed by a remote entity.

16. The computer-implemented method of claim 11, comprising:
determining, from at least one (i) the first set of operation data or (ii) the second set of operational data an optimized configuration for operating at least one component of the one or more components, wherein the optimized configuration causes the at least one component of the one or more components to enter into or maintain an operational state that is optimized for one of: power usage, mean time to failure, an expected error rate, hash rate, a ratio of hash rate and power usage, or a ratio of hash rate and waste heat.

17. The computer-implemented method of claim 11, wherein at least one of (i) the first set of operational data or (ii) the second set of operational data comprises current costs for a unit of energy.

18. The computer-implemented method of claim 11, wherein at least one of (i) the first set of operational data or (ii) the second set of operational data comprises a type of an energy source that powers the first set of one or more components or the second set of one or more components, respectively.

19. A non-transitory, computer-readable medium storing one or more instructions executable by a computer system to perform one or more operations, comprising:
collecting a first set of operational data of a first set of one or more components of a plurality of components based on one or more measurements performed using one or more sensors associated with the first set of one or more components; and
estimating a second set of operational data of a second set of one or more components different from the first set of one or more components based on the first set of operational data.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
collecting a first set of operational data of a first set of one or more components of a plurality of components based on one or more measurements performed using one or more sensors associated with the first set of one or more components; and
estimating a second set of operational data of a second set of one or more components different from the first set of one or more components based on the first set of operational data.
